(19) United States
(12) Patent Application Publication
(10) Pub. No.: US 2010/0157135 A1
(43) Pub. Date: Jun. 24, 2010

(54) Passive distance estimation for imaging algorithms

(75) Inventors: Tai Dossaji, Herts (GB); Duane Petrovich, London (GB); Juha Sakijarvi, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/317,236

(22) Filed: Dec. 18, 2008

(51) Int. Cl. H04N 5/232

(52) U.S. Cl. 348/348; 348/E05.045

(57) ABSTRACT

The specification and drawings present a new method, apparatus and software product for a passive estimation of a distance between a camera or an electronic device comprising the camera (e.g., a wireless camera phone) and an identified object or objects (e.g., automatically recognizable by the camera) having one or more known dimensions and located substantially in one object plane using an image (e.g., provided by the camera) for implementing by the camera/electronic device one or more imaging algorithms (e.g., autofocusing, flash adjustment, etc.) using that distance.

### TECHNICAL FIELD

The present invention relates generally to cameras or electronic devices comprising cameras and, more specifically, to passive estimation of distance between the camera and identified object/objects and implementing imaging algorithms (e.g., autofocusing, flash adjustment, etc.) using the estimated distance.

### BACKGROUND ART

In passive autofocus (AU) systems, the focusing is usually carried out by analyzing the captured image and positioning the lens where the image is sharpest, in the smallest number of steps to minimize the time taken for focusing. Typically, one time autofocus (AF) in an AF system of cameras is accomplished by moving the focusing from infinity towards a macro side with larger steps (usually called rough steps) until the focus value which is a measure of sharpness starts to decrease, indicating, that the peak has been passed. The area around the peak is then re-scanned with reduced step size, so that the sharpness peak may be located more precisely. This AF operation is usually time consuming which complicates a user experience while operating the camera.

Furthermore, in most passive continuous autofocus systems the main goal is to position the lens where the image is the sharpest and to maintain the focus state continuously, hence there are two distinct parts: 1) the initial search, and 2) tracking. The initial search may be similar to the one-time autofocus procedure outline above, but the tracking may be quite difficult due to the movement of the object.

Various algorithms have been proposed for estimating camera distance from objects, wherein most of these algorithms are active requiring sending an optical signal from a camera/laser to an object/target (e.g., laser ranging). Most of existing passive algorithms require that digital images were taken with multiple sensors/cameras, or requiring, e.g., panning and tilting cameras assuming that the angles between the cameras and the object are known, or using stereo pair (stereoscopic) imaging. Usually these methods are rather complex, time consuming and require substantial amount of computation power. Also existing art utilizing distance estimation has not been applied to improving AF, flash photography and user experience for image capturing.

In existing implementations the distance to the subject may be estimated using a lens position such that the error in the lens position estimates may be as much as 50%, because of mechanical tolerances and lack of lens position measurement sensors. The errors will be cumulative and will be reflected in the error of the power level for, e.g., flash assisted photography.

### DISCLOSURE OF THE INVENTION

According to a first aspect of the invention, a method may comprise: selecting one or more objects located substantially in one object plane using an image provided by a camera, wherein each of the one or more objects have one or more known dimensions; and estimating a distance between the camera and the object plane using all or selected dimensions of the one or more known dimensions for implementing one or more imaging algorithms using the distance.

According further to the first aspect of the invention, the one or more imaging algorithms may comprise a fine automatic autofocusing procedure, which may comprise: focusing a lens system of the camera to the distance; and carrying out an autofocus refinement search around the distance to move the lens system to a best focusing position.

Further according to the first aspect of the invention, the imaging algorithms may comprise adjusting flash parameters of the camera using the distance.

Still further according to the first aspect of the invention, each of the one or more known dimensions may be stored in a memory of the camera or provided through a user interface of the camera.

According yet further to the first aspect of the invention, the selecting of the one or more objects located substantially in the one object plane may comprise: selecting, using object recognition, a plurality of objects from the image provided by the camera, wherein each of the plurality of objects have the one or more known dimensions; estimating a plurality of distances from each of the plurality of objects to the camera; and further selecting the one or more objects located substantially in the one object plane from the plurality of objects.

According still further to the first aspect of the invention, at least one of the one or more objects may be a human face identified by the camera using face recognition.

According further still to the first aspect of the invention, the selecting and the calculating may be automatic.

According yet further still to the first aspect of the invention, the method may further comprise: determining one or more dimensions of a further object or one or more distances between objects in the one object plane using the one or more known dimensions.

According to a second aspect of the invention, a computer program product may comprise: a computer readable medium embodying a computer program code thereon for execution by a computer processor with the computer program code, wherein the computer program code comprises instructions for performing the method of claim 1.

According to a third aspect of the invention, an apparatus may comprise: an object selecting module, configured to select one or more objects in one object plane using an image provided by a camera, wherein each of the one or more objects have one or more known dimensions; and a calculation module configured to estimate a distance between the camera and the one object plane using all or selected dimensions of the one or more known dimensions to implement one or more imaging algorithms using the distance.

Still yet further according to the first aspect of the invention, the object selecting module and the calculation module may be parts of the camera or combined in one unit or a processor.

Further according to the third aspect of the invention, the one or more objects may comprise only one object.

Still further according to the third aspect of the invention, the apparatus may further comprise: a memory, configured to store all or selected dimensions of the one or more known dimensions.

According yet further to the third aspect of the invention, the apparatus may further comprise: an autofocus module, configured to focus a lens system of the camera to the distance and further configured to move the lens system to a best focusing position by carrying out an autofocus refinement search around the distance for implementing a fine automatic autofocusing procedure which is one of the one or more imaging algorithms.

According still further to the third aspect of the invention, an integrated circuit may comprise all or selected modules of the apparatus.
According yet further still to the third aspect of the invention, the apparatus may be a camera, an electronic device comprising a camera, or a camera-phone for wireless communications.

According further still to the third aspect of the invention, apparatus may further comprise: a flash determining module, configured to adjust flash parameters of the camera which is one of the one or more imaging algorithms.

Yet still further according to the third aspect of the invention, the object selecting module may be configured to identify, using object recognition, a plurality of objects from the image provided by the camera, wherein each of the plurality of objects have the one or more known dimensions, to estimate a plurality of distances from each of the plurality of objects to the camera, and to further select the one or more objects located substantially in the one object plane from the plurality of objects.

According to a fourth aspect of the invention, a processor may comprise: an object selecting module, configured to select one or more objects located substantially in one object plane using an image provided by a camera, wherein each of the one or more objects have one or more known dimensions; and a calculation module, configured to estimate a distance between the camera and the one object plane using all or selected dimensions of the one or more known dimensions to implement one or more imaging algorithms using the distance.

According further to the fourth aspect of the invention, the processor may further comprise: a memory, configured to store all or selected dimensions of the one or more known dimensions.

### BRIEF DESCRIPTION OF THE DRAWINGS

For a better understanding of the nature and objects of the present invention, reference is made to the following detailed description taken in conjunction with the following drawings, in which:

FIGS. 1a-1b are schematic representations of a focus search algorithm with an estimated distance as a starting point: a) moving a lens/lens system to a focusing position corresponding to the estimated object distance, and b) fine scanning of the lens/lens system to find best focusing of the object, according to an embodiment of the present invention;

FIG. 2 is a flow chart for implementing imaging algorithms (e.g., autofocusing, flash adjustment, etc.) using a passive distance estimation, according to an embodiment of the present invention;

FIG. 3 is a diagram demonstrating an algorithm for distance estimation between a chosen object and a camera, according to an embodiment of the present invention;

FIG. 4 is a diagram demonstrating an algorithm for choosing an object (e.g., a face) among a plurality of objects, according to an embodiment of the present invention; and

FIG. 5 is a block diagram of an electronic device (e.g., camera, camera phone, etc.) for implementing imaging algorithms (e.g., autofocusing, flash adjustment, etc.) using a passive distance estimation, according to an embodiment of the present invention.

### MODES FOR CARRYING OUT THE INVENTION

A new method, apparatus and software product are presented for a passive estimation of a distance between a camera or an electronic device comprising the camera (e.g., a wireless camera phone) and an identified object or objects (e.g., automatically recognizable by the camera) having one or more known dimensions and located substantially in one object plane using an image (e.g., provided by the camera) for implementing by the camera/electronic device one or more imaging algorithms (e.g., autofocusing, flash adjustment, etc.) using that distance.

With the introduction of object (e.g., human face) recognition and tracking algorithms in most camera systems, additional parameters such as feature size (e.g., human face size, distance between eyes, nose to eyes ratio, nose to mouth ratio and other possible face characteristics) become readily available which may be used to improve existing auto-focus, flash control, image quality and user experience, according to various embodiments of the present invention. The camera (or an electronic device comprising the camera) may have a memory comprising a look-up table (LUT) for common dimensions of objects such as human face, house, cars, buses, trains, planes, people, etc. with known dimensions (the LUT may also be country specific within the device). Also, dimensions of recognized objects may be provided through a user interface (UI) of the camera/electronic device as further discussed herein.

It is noted that some of the face detection (recognition) algorithms in existing cameras/electronic devices are able to roughly classify a human face based on the age (e.g., classify face into categories child, young, adult etc. or give rough age estimate). Based on this, a more accurate guess for the face size can be made, thus making estimation of the distance between the object (i.e., face) and the camera/device more accurate. In this embodiment the LUT of the camera/device may comprise various face dimensions based on the determined human age.

It is further noted that for the purpose of this invention the object (face) recognition (or detection) should be interpreted as detecting all objects/faces of interest which may be associated with corresponding dimensions in the LUT or may be entered by the user through the UI.

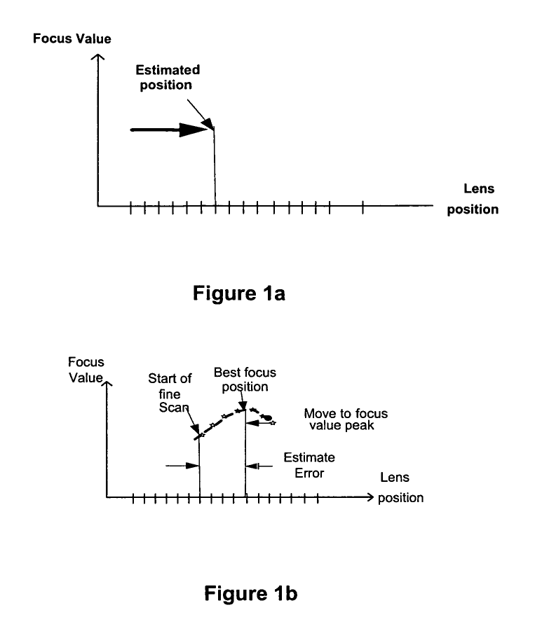

FIGS. 1a-1b show an example among others of schematic representations of a focus search algorithm in a camera using this estimated distance to the object as a starting point by, first, moving a lens/lens system to a focusing position corresponding to the estimated object distance as shown in FIG. 1a, and then by fine scanning the lens/lens system in order to find best focusing of the object as shown in FIG. 1b, according to an embodiment of the present invention. The procedure shown in FIGS. 1a-1b may be fully automatic and performed by the camera/electronic device.

According to another embodiment of the present invention, the imaging algorithms may comprise adjusting flash parameters of the camera using the estimated distance from the object (or object plane) to the camera by adjusting, e.g., flash luminance (light intensity or gain), flash exposure time, and/or flash white balance for correcting images. This may allow significant improvement in the quality of the images taken by the camera because the distance to the object/objects (or to one object plane) determined by the methodology disclosed herein may be substantially more accurate than determined by the known art just using a lens position (because of mechanical tolerances and lack of lens position measurement sensors in regular AF systems).

According to a further embodiment of the present invention, the imaging algorithms may be used for determining dimension/dimensions of object/objects (e.g., identified by the recognition system of the camera device or by the user on a display of the device) with unknown dimensions and/or unknown distances between objects located substantially in the one object plane which comprises at least one identified object with at least one known (i.e., reference) dimension (for instance, inputted by the user through the UI or stored in the memory of the camera/device), by using e.g., a simple geometrical ratio referenced to the object with know dimensions. For example, if a photograph of a house is taken and the user may input one of the dimensions of the house through the UI of the device, then from this single dimension the user may start estimating distances to other objects near the house (which are substantially in the same object plane). Another example where this application may be used is if the user is taking an image of a person who has caught a large fish, and if the user inputs via the UI a person's height, the camera system may measure the size of the fish. (the assumption being that the human height is typically known to the user).

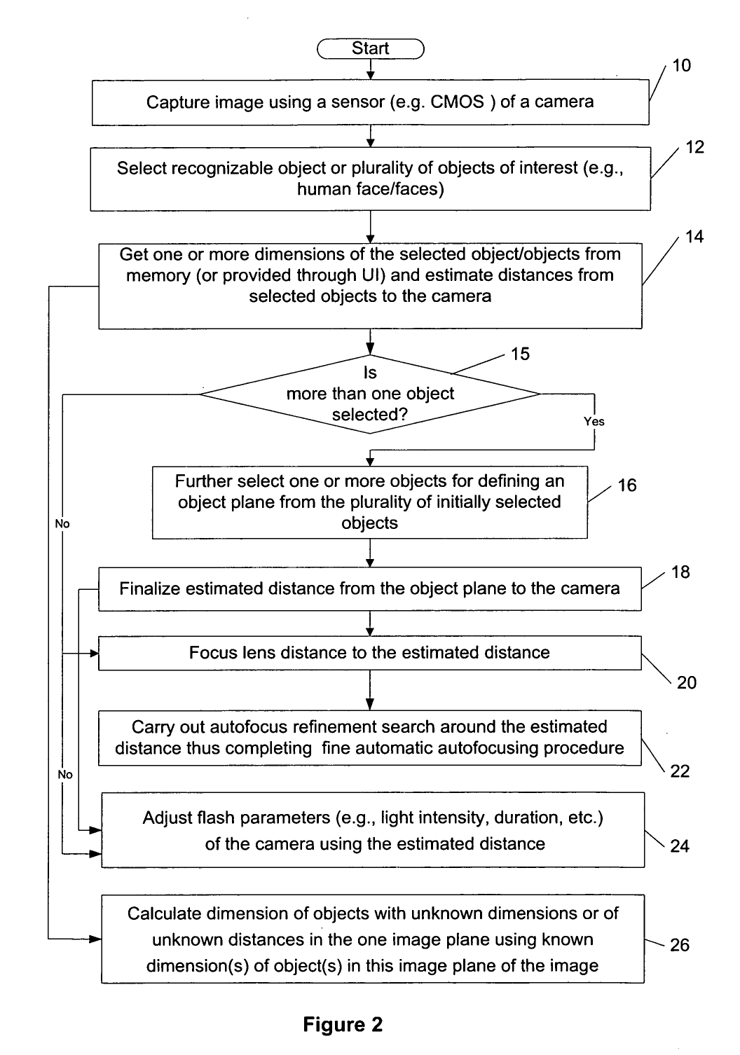

FIG. 2 shows an example of a flow chart for implementing imaging algorithms (e.g., autofocusing, flash adjustment, etc.) using a passive object distance estimation, according to an embodiment of the present invention. The procedure shown in FIG. 2 may be fully automatic and performed by the camera/electronic device.

The flow chart of FIG. 2 only represents one possible scenario among others. It is noted that the order of steps shown in FIG. 2 is not absolutely required, so in principle, the various steps may be performed out of order. In a method according to the embodiment of the present invention, in a first step 10, an image is captured using a sensor, e.g., such as a CMOS (complimentary metal oxide semiconductor) of a camera.

In a next step 12, a recognizable object or a plurality of objects of interest (e.g., human face/faces) are selected (e.g., automatically selected by the camera/electronic device), wherein the selected object or each of the selected plurality of objects has one or more known dimensions which may be stored in a device memory (e.g., as an LUT) or inputted by a user through a user interface (UI) of the camera or the electronic device comprising this camera. It is noted that the plurality of initially selected objects may be located in different object planes identified using the image provided by the camera. If no object of interest is found in step 12, then the process may default to the imaging algorithms of interest (e.g., autofocusing, flash, etc.) using a standard prior art technology presumably available in the camera/electronic device.

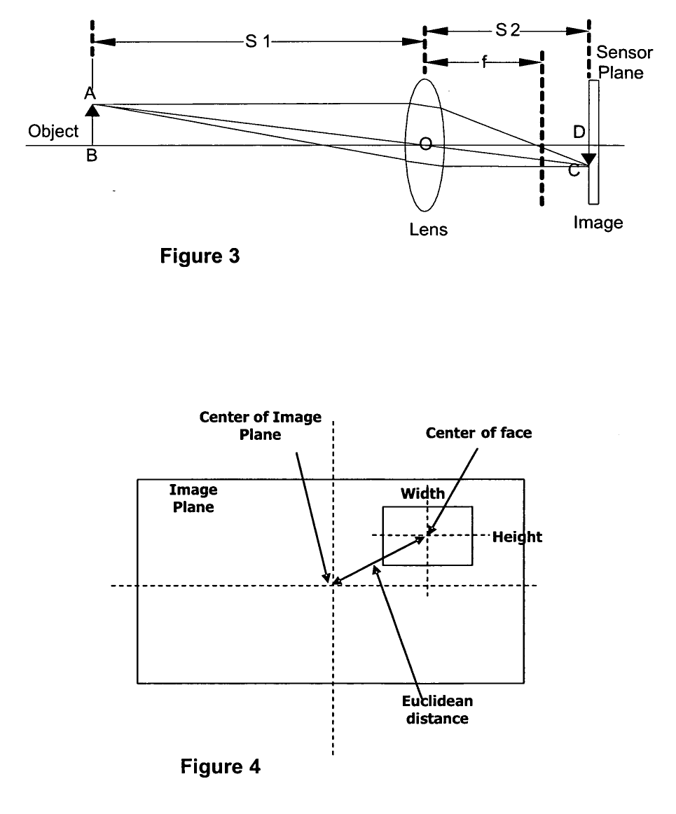

It is further noted that the process step 12 can be performed in a variety of ways. For example, this step 12 may start first by determining, e.g., using automatic recognition, whether there are face(s) in the image as preferred object(s) of reference (also possibly determining a human age as described herein, such that different face dimensions based on a human age stored in the LUT of the camera/device may be used). Then if no face(s) are found, it is further determined (e.g., again using automatic recognition) whether any other recognizable object(s) have their dimension(s) stored in a memory with LUT (look-up table) in the camera/electronic device. (As an alternative algorithm, even if the recognizable face/faces are found, other recognizable object/objects having their dimensions stored in the LUT memory may be determined as well). Then still further, if no recognizable object/objects (including face/faces) are found, the UI of the camera may display a slider determining in POI (point of interest) at least one object of interest not having its dimension stored in the LUT, possibly highlighting this object of interest such that the user may enter at least one dimension of this object (if known to the user) manually through the UI, one object of interest identified by the camera/device at a time. In a next step 14, one or more dimensions of the selected object/objects (including face/faces) are retrieved from the memory (including dimensions, if any, provided through the UI of the camera/device by the user) and distances to all selected objects are calculated (estimated) as illustrated in FIG. 3 showing a diagram demonstrating one possible algorithm among others for a distance estimation between each of the chosen objects and the camera/electronic device, according to one embodiment of the present invention.

Using a simple lens equations (a lens shown in FIG. 3 may be an equivalent thin lens for thin lens approximation of a lens system comprising multiple lenses of the camera) and trigonometry, a first approximation of the distance from the object with known dimension to the lens of the camera (S2 in FIG. 3 is a known dimension, e.g., it may be approximated by a focal length f of a lens system) as shown in FIG. 4, may be calculated as follows:

S1=(AB*f/CD)/Z (1),

wherein CD is a pixel size multiplied by a number of pixels and Z is a zoom factor. If AB (the object or face dimension), is known (e.g., an average human face has AB=180 mm), then the distance S1 may be estimated using Equation 1.

According to another embodiment, if two or more dimensions for a particular recognized object are available, e.g., in the LUT, the distance estimation using Equation 1 may be performed for all or selected available dimensions separately and then averaged, which may increase the accuracy of the distance estimation from that particular object to the camera/device. This averaged distance may be used in further steps of the process described herein.

After step 14 of FIG. 2, the process may go to step 15 and possibly to step 26 as shown in FIG. 2.

In a next step 15, it is determined whether more than one object is selected in step 12. If that is not the case, the process goes to steps 20 and 24. However, if it is determined that it is more than one object selected, in a next step 16, one or more objects substantially in one object plane are further selected from the plurality of initially selected objects in step 12 using a predetermined algorithm such that the estimated distance from this selected one object plane to the camera may be finalized in step 18.

One example among many others for implementing step 16 of FIG. 2 is illustrated in FIG. 4 showing a diagram demonstrating an algorithm for choosing an object (e.g., a face) among a plurality of objects, according to an embodiment of the present invention. In this example the object (or a few objects in one object plane), e.g., human face/faces are selected based on the size and the distance from the centre of the image (this algorithm may be used best if all selected objects are substantially in the same plane, e.g., within a certain predefined tolerance value). The weighting factor, e.g., may be calculated as a ratio of the object (or face) area and Euclidean distance to the object (or face) as illustrated in FIG. 4. Then the object/objects or face/faces in substantially one object plane with the largest weighting factor/factors may be selected in step 16 in FIG. 2 according to a predetermined algorithm. The weighting factor in this example may practically ensure that the object (e.g., the face) that is closest to the center of the screen may be selected. If there are two or more objects (e.g., faces) that are equidistance from the centre of the screen, then the largest object (e.g., face) may be selected. If, however, there are two or more objects (faces) with equal weighting factor then the object (e.g., the face) that is closer to the centre may be selected. It is noted that, according to an embodiment of the present invention, more than one object in one object plane may be selected in step 16 of FIG. 2 according to the predetermined algorithm (e.g., exceeding a certain threshold value preset for the weighting factor) and used for further processing as further explained herein.

If a significant number of objects of interest having different distances to the camera/device as estimated in step 14 of FIG. 2 (e.g., this option may be selected using threshold number(s) for a number of faces and/or other objects of interest having different estimated distance to the camera/device), then another criterion in addition to the method illustrated in FIG. 4 may be used for implementing step 16 of FIG. 2, e.g., by statistically evaluating distances estimated in step 14 from the camera/device to the multiple objects of interest. For example, in this embodiment the camera device may select one or more objects for defining an object plane, wanted by the user, based on finding a maximum in a statistical distribution of determined distances to the camera/device of all selected objects of interest (or only distances determined for a certain types of the recognizable objects such as, e.g., human faces).

Thus, in a next step 18, a distance to a plane with a highest location probability of the finally selected recognizable objects (or of a certain types of the recognizable objects, e.g., human faces) may be finalized by averaging the distances of the finally selected objects to the camera/device, which may increase accuracy of the distance estimation compared to one-object distance estimation which is practically performed in step 14 if only one object of interest is selected in step 12. Then the process goes to step 20 and to step 24 as shown in FIG. 2.

In a further embodiment, the process disclosed in steps 12-18 of FIG. 2 may be simplified if a presumed object plane is considered to be approximately in a vicinity of an object (e.g., a human face) located, e.g., in the middle of the picture: for example an initial object plane may be defined by this object at a moment when the user performs the “half-way” click (if this feature is available in the camera/device) for starting the autofocus procedure performed according to embodiments of the present invention. Alternatively, instead of defining the initial location of the object plane during this initial “half way” click, the approximate distance to this object pane may be set by the user of the camera/device directly through the UI (if this option is available in the camera/device). Then in step 16 only objects with the distances to the camera/device estimated in step 14 which are close enough (e.g., with a maximum predefined deviation) to the distance from the initially defined object plane at the moment of this “half-way” click (or provided by the user though the UI) may be selected from the objects selected in step 12.

In a further simplified embodiment, the object plane may be defined in step 12 to be coinciding with the object in the middle of the picture during this “half-way” click, such that only one object in the middle of the picture may be further considered with the calculated distance to the camera/device performed in step 14, which may eliminate the need to perform steps 15, 16 and 18 of FIG. 2.

In a next step 20 of FIG. 2, a lens (or a lens system) is focused to the estimated distance as demonstrated in FIG. 1 and in a next step 22, an autofocus refinement search around the estimated distance is implemented as demonstrated in FIG. 1b, thus providing a fine automatic autofocusing procedure according to an embodiment of the present invention.

It is further noted that the camera/electronic device most likely have a display/viewfinder such that the user may be able to see the quality of the picture he/she is going to take before taking the picture as a final step of the quality control of the autofocus procedure performed according to various embodiments of the present invention disclosed herein. Then if the user is not satisfied with the quality of the autofocussed image performed according to the embodiment of the present invention described herein, the user may renew the autofocus procedure by another “half-way” click (it is presumed that this “half-way” click was used first time to start autofocus procedure according to the embodiments of the present invention), then the process may repeat the autofocus procedure according to the embodiments of the present invention or alternatively the process may go to the prior art autofocus procedure if it is available in the device/camera as a default.

In a step 24, flash parameters (e.g., light intensity, exposure time, etc.) of the camera/electronic device may be adjusted using the estimated distance, according to another embodiment of the present invention, as described herein.

In a step 26, dimension/dimensions of object/objects with unknown dimensions and/or unknown distances between objects located in the one object plane comprising selected object/objects with known dimensions may be further calculated, using, e.g., a simple geometrical ratio referenced to the object/objects with known dimensions, according yet to another embodiment of the present invention, as described herein.

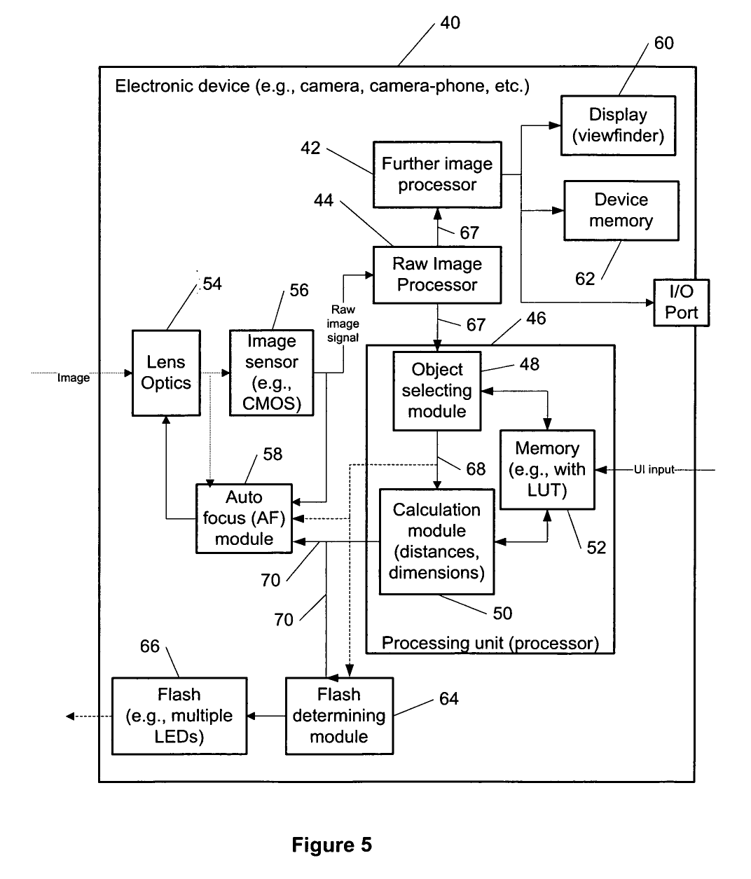

FIG. 5 shows an example among others of a block diagram of an electronic device (e.g., camera, camera-phone, a wireless device, etc.) 40 for implementing imaging algorithms (e.g., autofocusing, flash adjustment, etc.) as described herein (e.g. see FIG. 2) using a passive distance estimation, according to an embodiment of the present invention.

The camera 40 may comprise a lens optics 54 (e.g., a lens or a lens system) and an image sensor 56 (e.g., the CMOS sensor) for capturing the image to provide a raw image signal to a raw signal processor 44 which may provide an input signal 67 to processing unit (or processor) 46. The signal 67 may also be provided to a further signal processor 42 for subsequently providing an image to a display (viewfinder) 60 for viewing by a user, and if necessary to a device memory 62 for storing or to an input/output (I/O) port for forwarding to a desired destination. The electronic device 40 may further comprise a flash 66 comprising, e.g., multiple color LEDs (light emitting diodes) or other types of light sources, a flash determining block 64, and auto focus module 58 (other blocks are not shown).

The processor 46 may be a dedicated block or it may be incorporated within other processing modules (e.g., processor 42 or 44) of the electronic device 40. The processor 46 may comprise an object selecting module 48 (for recognizing, tracking and selecting object/objects of interest), a calculation module 50 (e.g., for calculating distance and/or object dimensions) and a processing memory 52 (which alternatively may be a part of the device memory 62). The module 48 may perform operation steps 12 described in the flow chart of FIG. 2 (alternatively step 14 and 15 may also be performed by the module 48) and further may provide an input signal 68 to the module 50.

It is further noted that generally the object selecting module 48 may be means for selecting or a structural equivalence (or an equivalent structure) thereof. Furthermore, the calculation module 50 can generally be means for estimating or a structural equivalence (or equivalent structure) thereof.

The module 50 may perform operation steps 14, 15, 16,18 and 26 described in the flow chart of FIG. 2 and provide corresponding signals to the flash determining block 64 and to the auto focus module 58 as shown in FIG. 5. Then the module 64 may perform operation steps 20 and 22 described in the flow chart of FIG. 2 by providing control signals to the lens optics 54, and the module 64 may perform operation step 24 described in the flow chart of FIG. 2 by providing a control signal to the flash 66 (assuming that module 64 may also perform a role of a flash controller).

According to an embodiment of the present invention, the modules 46, 48, 50 64, or 58 may be implemented as a software or a hardware module or a combination thereof. Furthermore, the block 46, 48, 50 64, or 58 may be implemented as a separate block or may be combined with any other module/block of the electronic device 40 or it may be split into several blocks according to their functionality. Moreover, it is noted that all or selected modules of the electronic device 40 may be implemented using an integrated circuit.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention may be provided as a computer program product comprising a computer readable storage structure (or a computer readable medium) embodying a computer program code (i.e., the software or firmware) thereon for execution by the computer processor.

It is noted that various embodiments of the present invention recited herein may be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method comprising:
selecting one or more objects located substantially in one object plane using an image provided by a camera, wherein each of said one or more objects have one or more known dimensions; and
estimating a distance between the camera and said object plane using all or selected dimensions of said one or more known dimensions for implementing one or more imaging algorithms using said distance.

2. The method of claim 1, wherein said one or more imaging algorithms comprise a fine automatic autofocusing procedure, which comprises:
focusing a lens system of said camera to said distance; and
carrying out an autofocus refinement search around said distance to move said lens system to a best focusing position.

3. The method of claim 1, wherein said imaging algorithms comprise adjusting flash parameters of said camera using said distance.

4. The method of claim 1, wherein each of said one or more known dimensions is stored in a memory of said camera or provided through a user interface of said camera.

5. The method of claim 1, wherein said selecting of the one or more objects located substantially in said one object plane comprises:
selecting, using an object recognition, a plurality of objects from the image provided by the camera, wherein each of said plurality of objects have said one or more known dimensions;
estimating a plurality of distances from each of said plurality of objects to the camera; and
further selecting said one or more objects located substantially in said one object plane from said plurality of objects.

6. The method of claim 1, wherein at least one of said one or more objects is a human face identified by the camera using a face recognition.

7. The method of claim 1, wherein said selecting and said calculating are automatic.

8. The method of claim 1, wherein said method further comprising:
determining one or more dimensions of a further object or one or more distances between objects in said one object plane using said one or more known dimensions.

9. A computer program product comprising: a computer readable medium embodying a computer program code thereon for execution by a computer processor with said computer program code, wherein said computer program code comprises instructions for performing the method of claim 1.

10. An apparatus, comprising:
an object selecting module, configured to select one or more objects in one object plane using an image provided by a camera, wherein each of said one or more objects have one or more known dimensions; and
a calculation module configured to estimate a distance between the camera and said one object plane using all or selected dimensions of said one or more known dimensions to implement one or more imaging algorithms using said distance.

11. The apparatus of claim 10, wherein said object selecting module and said calculation module are parts of the camera or combined in one unit or a processor.

12. The apparatus of claim 10, wherein said one or more objects comprises only one object.

13. The apparatus of claim 10, further comprising:
a memory, configured to store all or selected dimensions of said one or more known dimensions.

14. The apparatus of claim 10, further comprising:
an autofocus module, configured to focus a lens system of said camera to said distance and further configured to move said lens system to a best focusing position by carrying out an autofocus refinement search around said distance for implementing a fine automatic autofocusing procedure which is one of the one or more imaging algorithms.

15. The apparatus of claim 10, wherein an integrated circuit comprises all or selected modules of said apparatus.

16. The apparatus of claim 10, wherein said apparatus is a camera, an electronic device comprising a camera, or a camera-phone for wireless communications.

17. The apparatus of claim 10, further comprising:
a flash determining module, configured to adjust flash parameters of said camera which is one of said one or more imaging algorithms.

18. The apparatus of claim 10, wherein said object selecting module is configured to identify, using an object recognition, a plurality of objects from the image provided by the camera, wherein each of said plurality of objects have said one or more known dimensions, to estimate a plurality of distances from each of said plurality of objects to the camera, and to further select said one or more objects located substantially in said one object plane from said plurality of objects.

19. A processor, comprising:
an object selecting module, configured to select one or more objects located substantially in one object plane using an image provided by a camera, wherein each of said one or more objects have one or more known dimensions; and
a calculation module, configured to estimate a distance between the camera and said one object plane using all or selected dimensions of said one or more known dimensions to implement one or more imaging algorithms using said distance.

20. The processor of claim 19, further comprising:
a memory, configured to store all or selected dimensions of said one or more known dimensions.
